(19) United States
(12) Patent Application Publication
(10) Pub. No.: US 2010/0169365 A1
(43) Pub. Date: Jul. 1, 2010

(54) Research collaboration system and method with data-driven search capability

(75) Inventors: Geoffrey L. Chupp, Madison, CT (US); Steven J. Greenberg, Westport, CT (US)

Correspondence Address: MINTZ LEVIN COHN FERRIS GLOVSKY & POPEO, ONE FINANCIAL CENTER, BOSTON, MA, 02111, US

(73) Assignee: ORPHANDATA, Westport, CT (US)

(21) Appl. No.: 12/653,298

(22) Filed: Dec. 11, 2009

Related U.S. Application Data
(60) Provisional application No. 61/201,572, filed on Dec. 11, 2008.

(51) Int. Cl. G06F 17/30

(52) U.S. Cl. 707/769; 707/E17.108

(57) ABSTRACT

A research collaboration system and method with a data-driven search capability is provided that facilitates collaboration among researchers and/or others interested in research.

### CROSS-REFERENCE TO RELATED APPLICATIONS

The present application claims the benefit of priority under 35 U.S.C. §119(e) from U.S. Provisional Patent Application Ser. No. 61/201,572, filed Dec. 11, 2008, which is hereby incorporated by reference herein in its entirety.

### FIELD OF THE INVENTION

Embodiments of the present invention relate to systems and methods for facilitating and promoting collaboration among researchers and/or others interested in sharing research or other data and, more particularly, to a collaboration system and method with a data-driven search capability.

### BACKGROUND OF THE INVENTION

Typically, a scientific researcher generates through the ordinary course of research on a given topic a subset of data that is not incorporated into the researcher's manuscript or other published work on that topic. For example, such data may include findings or results of little or no relevance to the primary research topic, or data that is more relevant to avenues for continued or future research on that topic or other topics. As a result, this data is commonly “orphaned” or left unused by the researcher, even though it may have value to other scientists and even the researcher who generated it. For example, unbeknownst to the researcher, this data may have particular value to scientists in other disciplines.

In view of the foregoing, it would be desirable to provide systems and methods that facilitate and promote collaborations regarding research, including collaborations that cross traditional disciplinary lines (“trans-disciplinary collaboration”).

### SUMMARY OF THE INVENTION

Embodiments of the present invention relate to systems and methods for facilitating and promoting collaboration among scientific researchers and/or others interested in their research. In some embodiments, such systems and methods promote trans-disciplinary collaboration among scientists based on searches directed to the substance of the research. This is in contrast to systems that create social or professional networks by highlighting social or biographical similarities in groups of users.

In some embodiments, a data-driven search capability is provided that identifies targets for research collaboration. In some embodiments, the data-driven search is based on search criteria selected by a user from one or more predetermined lists of terms and/or phrases related to the substance of a research topic. For example, in the context of biomedical research, the data-driven search may be based on search criteria selected by a user from one or more predetermined lists of genes, pathways, and/or diseases. In some embodiments, the one or more predetermined lists of terms and/or phrases may be predefined, for example, by one or more parties and/or individuals having specialized knowledge about particular research topics. In some embodiments, the data-driven search may be based on keywords or strings directed to the substance of a research topic (e.g., asthma) entered by a user into one or more open-ended response fields. In some embodiments, the searchable research entries may be cataloged by the same terms and/or phrases (e.g., genes, pathways, and/or diseases), and/or variants thereof (e.g., synonym genes), and/or searchable by the keywords, strings, and/or variants thereof. In some embodiments, such research collaboration is expected to make use of otherwise abandoned or unused research data, thus advancing the cause of scientific research and adding value to the research community at large. In some embodiments, the research collaboration system may be configured to allow a user to create one or more user groups. In some embodiments, the research collaboration system may be configured to provide automatic notification to a user when new research data is added to the research collaboration system.

The foregoing and other features, aspects, and advantages of the present invention will be more apparent from the following detailed description of exemplary embodiments of the present invention.

### BRIEF DESCRIPTION OF THE DRAWINGS

For a better understanding of the present invention, reference is made to the to following description, taken in conjunction with the accompanying drawings, in which like reference characters refer to like parts throughout, and in which:

FIG. 1 is a block diagram of a system for facilitating and promoting research collaboration in accordance with an embodiment of the present invention;

FIG. 2 is a flowchart illustrating the stages involved in providing a data-driven search capability for research data in accordance with an embodiment of the present invention; and

FIGS. 3-6 are illustrative display screens of a research collaboration system in accordance with various embodiments of the present invention.

### DETAILED DESCRIPTION OF THE INVENTION

The following description focuses primarily on an illustrative use of facilitating and promoting collaboration among medical researchers and/or others interested in medical research. In other embodiments, aspects of the present invention related to data-driven and categorical search capabilities may be applied to facilitate or promote collaboration in any other research areas, including without limitation, botany, heart disease, psychology, seismology, materials science, aerospace, engineering, physics and economics.

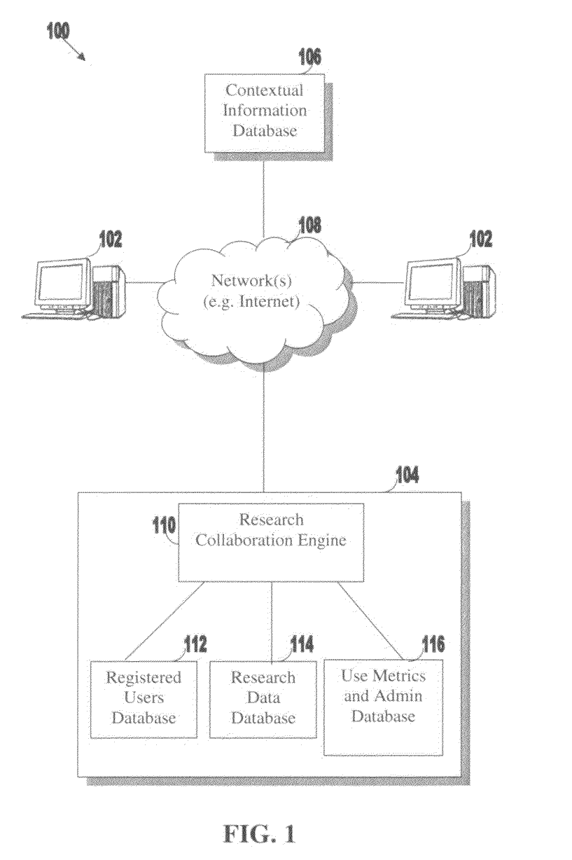

FIG. 1 is a block diagram of a system 100 for facilitating and promoting collaboration among researchers and/or others interested in such research (e.g., research centers or sources of funding) according to an embodiment of the present invention. System 100 includes user computers 102, a research collaboration system 104, and contextual information system (e.g., a database) 106, all of which may communicate over one or more networks 108 (e.g., the Internet). Each user computer 102, collaboration system 104, and contextual information system 106 may be in electrical communication with the one or more networks 108 via any suitable communication capability, including without limitation, a cable or satellite connection, a local area network (“LAN”), any other suitable wired, wireless, or optical connection, or a combination thereof. Collaboration system 104 may include a research collaboration engine 110, a database 112 having information about users of system 104 (e.g., registered researchers), a database 114 having information posted by users about various research data (e.g., proposed projects and/or results of past projects), including information not otherwise available in a primary researcher's manuscript or other published work, and a database 116 having information about usage of collaboration system 104 and/or other administrative information.

Each user computer 102 may include any suitable computing equipment to allow a user to enter, search, respond, or submit information to or from research collaboration system 104. In some embodiments, user computer 102 may receive and transmit to collaboration system 104 information required or otherwise requested for the user to establish an account with collaboration system 104 (e.g., user name, password, contact information, title, company or other affiliations). In some embodiments, user computer 102 may transmit user inputs to collaboration system 104 that correspond to one or more research categories and/or keywords of interest to the user for use by research collaboration engine 110 to search the research data within database 114 and return results to the user. In some embodiments, research data may include research abstracts and/or reagent listings. Furthermore, user computer 102 may transmit information to collaboration system 104 information that constitutes or relates to research information intended for inclusion within database 114, such as research information that is not otherwise available in a research manuscript or other published work due to its marginal or lack of relevance to a primary research topic or lack of funding. User computer 102 may also facilitate a variety of other functions, including without limitation, the receipt and display of responses regarding research information submitted by a user and/or communicating or scheduling contact with third parties interested in submitting information.

In some embodiments, as shown in FIG. 1, user computer 102 may be a desktop computer. In some embodiments, user computer 102 may be a laptop computer, telephone (e.g., mobile phone), personal digital assistant (“PDA”), BlackBerry device, or any other suitable computing device. User computer 102 may have a web browser (e.g., Internet Explorer, Netscape Navigator, Mozilla Firefox) operating thereon to facilitate communications over the one or more networks 108. In some embodiments, the web browser may access and read marked-up documents (e.g., HTML documents) from collaboration system 104 and may also, if necessary, translate and render those documents into pages viewable by a user of user computer 102. These rendered pages may include data entry fields (e.g., pull-down menus with predetermined selections and/or open-ended response fields) into which the user may enter and submit, in some embodiments, personal information such as name, address, social security number, telephone number, e-mail address, income information, job title, and/or employer information. In some embodiments, these pages may include one or more user-selectable search categories and/or data entry fields into which the user can enter keywords for use in a search for research information within database 114. In some embodiments, collaboration system 104 may enable a user to perform searches of research data based on user selections from predetermined keywords or phrases related to a research topic (e.g., heart disease or seismology). In some embodiments, in the biomedical context, searches may be based on user selection from one or more predetermined lists of gene symbols, pathways and/or diseases. While only two user computers 102 are shown in FIG. 1 to avoid overcomplicating the drawing, embodiments of system 100 may often include multiple user computers 102 for multiple users to submit and/or search for research data within to collaboration system 104, as well as collaborate with others.

Research collaboration engine 110 may include any suitable hardware and/or software, including servers and/or processors for receiving and processing research information from users, requests from users computers 102 for searches of the research information, and/or other information received by collaboration system 104 from user computers 102 and/or contextual information system 106. In some embodiments, research collaboration engine 110 may include one or more servers for serving website pages developed using Microsoft ASP 3.0 and Microsoft SQL Server 2000, as well as various third party and proprietary applications suitable to run in a Microsoft Windows server environment.

In some embodiments, research collaboration engine 110 may provide different levels of user security and/or may vary the options or data presented to the user depending on, for example, whether the user of user computer 102 is an anonymous visitor (i.e., open access features), a registered user (i.e., closed access features, e.g., for businesses, institutions or other individuals), such as a researcher having submitted appropriate login credentials (e.g., user name and password) or an administrator of collaboration system 104 with authenticating credentials. In some embodiments, only users who have logged in successfully may be permitted to access reagent data, post research data, or access other options or features provided by collaboration system 104. Research collaboration engine 110 may deny requests for access to data (e.g., particular pages of a website served by research collaboration engine 110) when an end user of user computer 102 submits invalid login information. Conversely, such access may be granted and/or collaboration system 104 may track and store use metrics in database 116, including without limitation, login time or web pages visited in response to a successful login by a user. In some embodiments, collaboration system 104 may provide a mechanism for a registered user to retrieve forgotten login information. That is, in response to a user submitting a registered email address, research collaboration engine 110 may send the user's login information to that address, according to some embodiments.

Once authenticated, research collaboration engine 110 may provide a registered user with options related to managing the user's account, such as changing contact information (e.g., email address and/or telephone number), preferences, and/or general profile information. Such data associated with a registered user's account may be stored in database 112, which is communicatively coupled to research collaboration engine 110. In some embodiments, research collaboration engine 110 may provide an authenticated user with access to an interactive interface (e.g., one or more display screens) from which the user can manage the research data (e.g., research abstracts and/or reagent listings) submitted by the user to collaboration system 104, and add, modify, or delete entries as necessary. In some embodiments, research collaboration engine 110 may be configured to allow users to create their own user groups. This feature, according to some embodiments, may allow a user to make his or her research listing submitted to the collaboration system 104 available only to select other users and/or user groups. One exemplary way of creating such a user group may include configuring the collaboration system 104 to have a selection means (e.g., a check box or a radio button) positioned next to each of the user's research listings, wherein selecting the selection means for a particular listing will limit the availability of that listing to a subset, or user group, of the entire community of users of the collaboration system 104. In some embodiments, a user may define what other users comprise a particular user group and which of his or her research listings are to be allocated to a particular user group. A user's research listing may be stored in database 114, which is also communicatively coupled to research collaboration engine 110.

In some embodiments, research collaboration engine 110 may provide authenticated users of collaboration system 104 with access to contact information (e.g., email address, telephone number, and/or username) for any party that has inquired as to any research data submitted by that user. In some embodiments, research collaboration engine 110 may provide authenticated users with options related to messaging such interested parties. The use of such messaging through collaboration system 104 may allow parties, according to some embodiments, to remain anonymous to one another until after it has been determined (e.g., through messaging) that a viable opportunity to collaborate exists with respect to the research data and/or that no conflict of interest exists between the parties. Such messages may be sent from user to user, such that when a registered user sends a message from his or her workspace within collaborated system 104, the message is displayed within the “inbox” of the recipient user's workspace within collaboration system 104. In some embodiments, by default or in response to a request from one or more users, messages between users of collaboration system 104 may be routed through a third party (e.g., an employee of collaboration system 104). The third party may review the communications to assess the parties' willingness or ability to collaborate and/or to assist the parties to settle on terms of such collaboration. In some embodiments, the third party may run a conflict check to determine whether the parties are adverse or potentially adverse (e.g., competitors). Further, rather than users messaging one another about submitted research data, some embodiments of the present invention may include an automatic notification system. More specifically, the collaboration system 104, including components contained therein, may be configured with an alert feature. This feature may give users the option to be notified by the collaboration system whenever new data is added to the collaboration system 104. The alert feature functionality may include giving a user the ability to define specific subject matter that the user is seeking and would like to be notified about. In some embodiments, a user may set up various notification parameters and choose to be notified about numerous different research topics. Notification means may include without limitation a pop-up message on user computer 102 or an email sent to a user's email account.

In some embodiments, once collaboration system 104 has successfully matched users desirous of collaborating with respect to a research listing posted through collaboration system 104, such users may be presented with an option (e.g., data entry field or user-selectable button) the selection of which notifies collaboration system 104 of such collaboration. In response to such notification, collaboration system 104 may remove the research listing from database 114 and/or disable it from being displayed in response to future searches through collaboration system 104. In some embodiments, collaboration system 104 may cause the research listing to be displayed (e.g., on a homepage of collaboration system 104 or in response to future searches) together with an indicator that a collaboration is under way. In some embodiments, collaboration system 104 may include a counter (e.g., on a homepage of collaboration system 104) that is incremented each time collaboration system 104 facilitates a collaboration. In some embodiments, collaboration system 104 may disseminate message notifications to at least a subset of registered users of collaboration system 104 (e.g., to their workspaces within collaboration system 104 or to external email addresses) when users are matched through collaboration system 104 and/or to keep users apprised of the results of collaborations facilitated by collaboration system 104 (e.g., future research papers or publications resulting from the collaborations). In some embodiments, collaboration system 104 may track the number of times each registered user has participated in a collaboration through collaboration system 104, may store such information (e.g., in database 116) and/or may display such information within collaboration system 104 (e.g., together with research listings authored by that user, to an administrator of collaboration system 104, and/or in response to a request by other end users for information regarding that user).

Once an administrator of collaboration system 104 is authenticated by collaboration system 104, research collaboration engine 110 may provide the administrator with options related to managing collaboration system 104. In some embodiments, research collaboration engine 110 may provide the administrator with access to an interactive interface (e.g., one or more display screens) from which the administrator can manage registered users (e.g., create, modify, or delete). In some embodiments, research collaboration engine 110 may provide the administrator with options to send a mass message to all or a subset of the workspaces within collaboration system 104 and/or an email to all or a subset of the external email addresses of registered users (e.g., external email addresses entered by registered users within their respective profiles within collaboration system 104), such as the subset of users who have attempted to contact the author of any particular research entry within collaboration system 104.

In some embodiments, research collaboration engine 110 may allow the administrator to view usage reports, edit all or any subset of data entered by users, download lists of users (e.g., in Comma-Separated Values (CSV) format or other format(s)), edit lookup data, such as lists of diseases, molecules or genes, and/or edit or configure certain portions of a website served by collaboration system 104 such as homepage copy and/or other areas. Such editable or configurable information may be stored in whole or in part within database 116. In some embodiments, research collaboration engine 110 may periodically (e.g., daily, weekly, etc.) email to the administrator of collaboration system 104 a summary of activity including, for example, the number or identity of one or more new users, the number or a synopsis of new research listings, the number of contact inquiries to researchers, the number of inquiry responses from researchers, and/or the top n (e.g., 5) referrers of users to collaboration system 104. Some or all of this data, and or other data regarding metrics of usage with respect to collaboration system 104, may be collected by engine 110 and stored in database 116. It will be understood that although databases 112, 114, and 116 are shown in FIG. 1 as separate databases, other storage arrangements are possible and are fully contemplated as being within the scope of the present invention. For example, in some embodiments, databases 112, 114, and 116 may be logical subdivisions of the same database.

Contextual information system (e.g., database) 106 may include information that is accessed by collaboration system 104 in order to supplement or enhance the content made available by collaboration system 104 to users. In some embodiments, contextual information system 106 may be the National Library of Medicine's back-end database (NCBI). Periodically (e.g., daily or weekly), research collaboration engine 110 and/or other suitable hardware and/or software (e.g., an external application) may access contextual information system 106 in order to determine whether database 116 includes any new data not already existing within database 114, such as lookup data (e.g., gene and molecular data). If so, such data may be downloaded and imported into database 114.

In some embodiments, contextual information system 106 may be a journal, periodical, or other system (e.g., international conference) that publishes research abstracts (e.g., which may or may not have been peer reviewed) and/or research papers. In some embodiments, research abstracts or papers may be imported (e.g., downloaded) into collaboration system 104 (e.g., database 114), searchable by users of collaboration system 104 (e.g., without downloading them to collaboration system 104), and/or viewable through displays rendered by collaboration system 104. In some embodiments, one or more abstracts or papers may have an associated point of contact (e.g., author, publishing entity), who may also be a registered user of collaboration system 104 to enable other users interested in that research paper or abstract to initiate a collaboration with that point of contact.

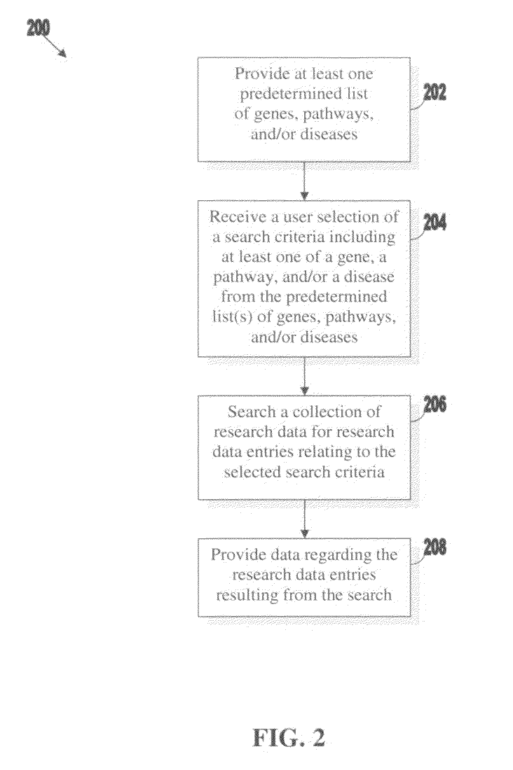

FIG. 2 shows an embodiment of a flowchart 200 that illustrates the stages involved in facilitating research collaboration in accordance with an embodiment of the present invention. At stage 202, at least one predetermined list of genes, pathways, and/or diseases may be provided. In some embodiments, research collaboration engine 110 may cause one or more predetermined lists of genes, pathways, and/or diseases to be provided to, and subsequently displayed by, user computer 102. At stage 204, a user selection of a search criteria may be received, including at least one of a gene, pathway, and/or disease from one or more predetermined lists of genes, pathways, and/or diseases. At stage 206, a collection of research data (e.g., from database 114) may be searched for research data entries relating to the selected search criteria. At stage 208, research data resulting from the search may be provided for display to the user, according to some embodiments.

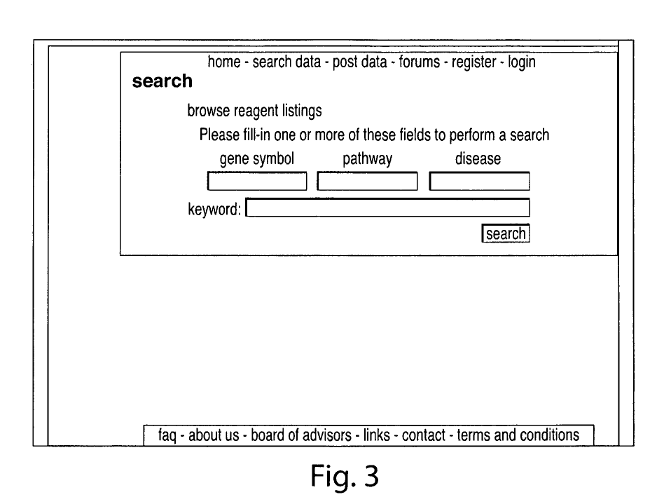

FIGS. 3-6 are illustrative display screens of the collaboration system 104 in accordance with various embodiments of the present invention. FIG. 3 is an illustrative display screen from which a user (e.g., researcher) may launch a search for research data. Options (e.g., drop-down menus) to select from one or more predetermined lists of gene symbols, pathways, and/or diseases may be provided in some embodiments. The one or more predetermined lists of gene symbols may include one or more (e.g., all) of known genes and synonyms in the human genome. This list may be generated and/or updated on a weekly basis (e.g., by a third party such as the National Institutes of Health (NIH)) and downloaded or otherwise entered into collaboration system 104. The dataset (e.g., stored in database 114) may be organized such that there is a common link for any data that is gene-related and that may be entered under synonym gene names. In some embodiments, the same may be true for the pathway and/or disease search capabilities. This may increase the number of connections and/or collaborations that collaboration system 104 generates, by ensuring that whenever possible researchers and/or other parties are linked, even if they are using different terms for the same gene (which is common across disciplines), pathway, and/or disease.

In some embodiments, the one or more predetermined list of pathways may include one or more (e.g., all) of:

### Angiogenesis

### Apoptosis

Cell cycle regulation
Cell differentiation
Cell stimulation
Cellular adhesion and migration
Cytokines and signaling molecule
DNA regulation and repair
Extracellular matrix
Inflammation and immunity
Malignant transformation
Nerve conduction and function

### Oxidatants/antioxidants

Remodeling and fibrosis
Signal transduction
Stem cells.

In some embodiments, the one or more predetermined list of diseases may include one or more (e.g., all) of:

### Allergy and Immunology

### Bone and Joints/Orthopedic

### Cancer

### Cardiovascular

### Critical Illness

### Dermatological

### Endocrine

### Gastroenterology

### Genetic

### Head and Neck

### HIV/AIDS

### Infectious Diseases

### Neurologic

### Opthalmology

### Organ Transplantation

### Psychiatric

### Pulmonary

### Reproductive Diseases

### Urologic

### Vascular.

In some embodiments, an open-ended response field may be provided into which the user may enter search terms or phrases. In some embodiments, some or all of the search fields provided by the collaboration system 104 (e.g., gene search field) may operate in an auto-complete capacity, using client-side JavaScript and server-side queries made in real time (sometimes referred to as AJAX). Once a user enters three letters into a search field, the user may be presented with a list of some or all matches and/or partial matches (e.g., including synonyms), according to some embodiments. The search of the research data (e.g., including searches for one or more synonyms of a search term entered by the user) may be performed in response to a user's selection of the “search” option once the search criteria has been specified.

In some embodiments, some or all displays provided by the collaboration system 104 may contain links to features provided by the collaboration system 104, context-sensitive menu options (e.g., options that change depending on the display currently being viewed), and/or other displays (e.g., “home,” “search data,” “post data,” “forums,” “register,” “login,” “FAQ,” “about us,” “board of advisors,” “links,” “contact,” or “terms and conditions”). In some embodiments, a “tell a colleague” link may be provided on some or all research data listings, allowing a user to send the listing to someone else (e.g., via email). In some embodiments, a “report listing” option may be provided for notifying an administrator of offensive or inappropriate content in a research listing. In some embodiments, a suggestion or comments option may be provided for allowing users to send feedback regarding the collaboration system 104.

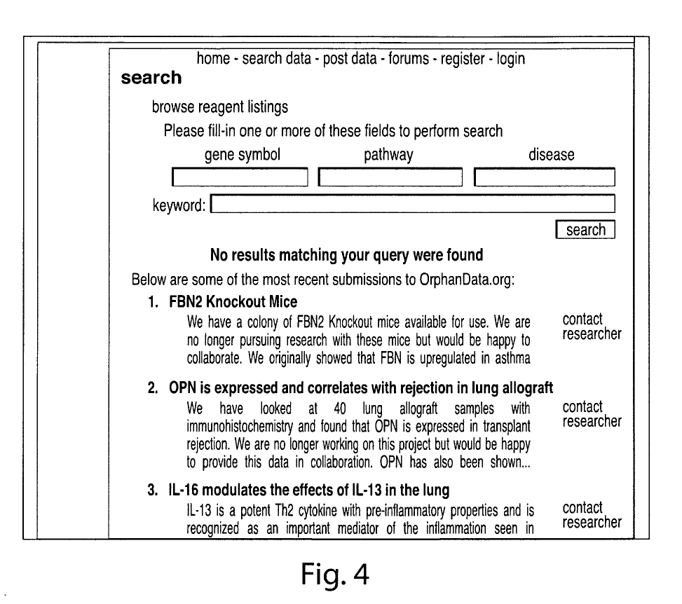

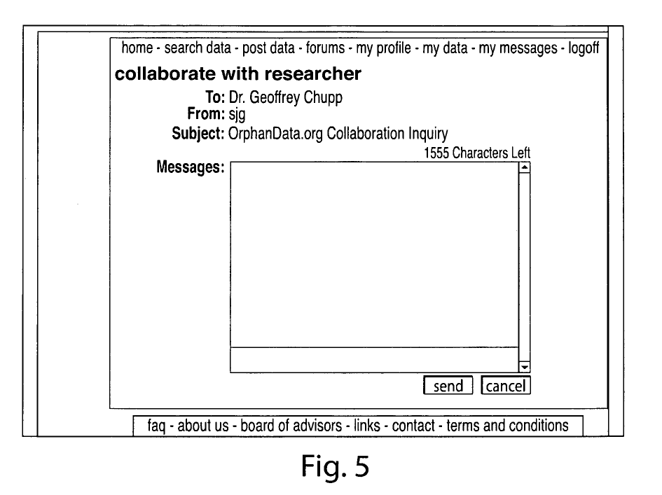

FIG. 4 is an illustrative display of search results resulting from a search of the research data. Upon displaying the results (e.g., a list of results), a user may be provided with an option to contact the author of the research listing using, for example, the contact form shown in FIG. 5. If no matches are found based on the selected search criteria, other research listings may be displayed such as, for example, some or all of the most recent research listings submitted to the collaboration system 104, together with a summary of the listings, according to some embodiments.

FIG. 5 is an illustrative display from which a user interested in research can contact the author of a research listing. From this display, the user may login (if such login did not already occur) to cause the user's contact information stored by the collaboration system 104 to be entered into the relevant data fields. Alternatively, the user may be able to enter the contact information manually. Upon completion of the contact request and selection of the send option, a message (e.g., email or intra-system message) may be generated by the collaboration system 104 and sent to the author of the research listing. In some embodiments, the author of the research listing may remain anonymous until the author decides to reveal his or her contact information to the user interested in the research. The message to the author may contain the contact information for the inquiring party and/or a link to a display in which such information is displayed. In some embodiments, based on information presented to users of the collaboration system 104 (e.g., contact information and/or selectable options), users may initiate contact with each another via the collaboration system 104 (e.g., messaging, or a video and/or telephonic conferencing scheduling system and communication interface) and/or through an external resource (e.g., telephone, video conferencing capability, email).

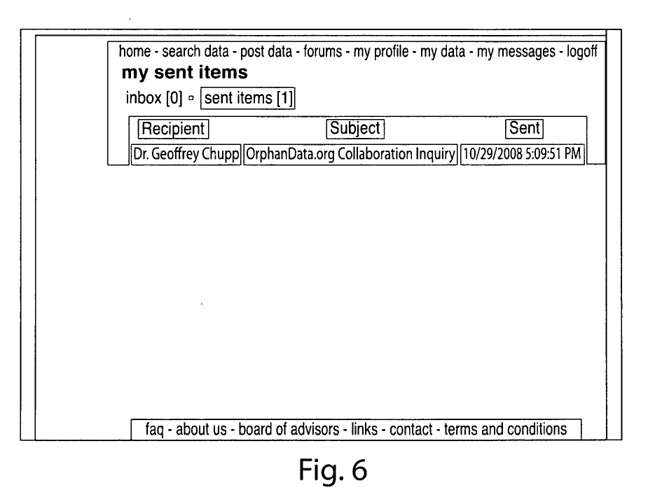

FIG. 6 is an illustrative display of a message workspace provided by the collaboration system 104 for a registered user of the collaboration system 104. From this workspace, the user may be permitted to send and receive messages regarding research data and/or navigate to other portions of, or features provided by, the collaboration system 104.

Thus it is seen that systems and methods are provided for facilitating and promoting collaboration among researchers and/or other interested in research. Although particular embodiments have been disclosed herein in detail, this has been done by way of example for purposes of illustration only and is not intended to be limiting with respect to the scope of the appended claims, which follow. In particular, it is contemplated by the inventors that various substitutions, alterations, and modifications may be made without departing from the spirit and scope of the invention as defined by the claims. Other aspects, advantages, and modifications are considered to be within the scope of the following claims. The claims presented are representative of the inventions disclosed herein. Other, unclaimed inventions are also contemplated. The inventors reserve the right to pursue such inventions in later claims.

Insofar as embodiments of the invention described above are implementable, at least in part, using a computer system, it will be appreciated that a computer program for implementing at least part of the described methods and/or the described systems is envisaged as an aspect of the present invention. The computer system may be any suitable apparatus, system or device, electronic, optical or a combination thereof. In some embodiments, the computer system may be a programmable data processing apparatus, a general purpose computer, a Digital Signal Processor, an optical computer or a microprocessor. The computer program may be embodied as source code and undergo compilation for implementation on a computer or may be embodied as object code, according to some embodiments.

It is also conceivable that in some embodiments, some or all of the functionality ascribed to the computer program or computer system aforementioned may be implemented in hardware, for example, by means of one or more application-specific integrated circuits and/or optical elements. In some embodiments, the computer program can be stored on a carrier medium in computer usable form (e.g., a computer readable medium), which is also envisaged as an aspect of the present invention. The carrier medium may be solid-state memory, optical or magneto-optical memory, such as a readable and/or writable disk (e.g., a compact disc (CD) or a digital versatile disc (DVD)) or magnetic memory (e.g., disk or tape), according to some embodiments, and the computer system may utilize the program to configure it for operation. In some embodiments, the computer program may be supplied from a remote source embodied in a carrier medium, such as an electronic signal, including a radio frequency carrier wave or an optical carrier wave.

What is claimed is:

1. A research collaboration system, comprising:
at least one processor configured to:
provide at least one predetermined list of terms and/or phrases related to a research topic;
receive a user selection of a search criteria comprising at least one of a term and/or phrase from the at least one predetermined list of terms and/or phrases related to the research topic; and
based on the user selection, search a collection of research data for one or more research data entries relating to said search criteria.

2. The research collaboration system of claim 1, wherein the research collaboration system is further configured to allow a user to create one or more user groups.

3. The research collaboration system of claim 1, wherein the research collaboration system is further configured to provide automatic notification when new research data is added to the research collaboration system.

4. A research collaboration system, comprising:
a research collaboration engine configured to:
provide at least one predetermined list of genes, pathways, and/or diseases;
receive a user selection of a search criteria comprising at least one of a gene, pathway, and/or disease from the at least one predetermined list of genes, pathways, and/or diseases; and
based on the user selection, search a collection of research data for one or more research data entries relating to said search criteria.

5. The research collaboration system of claim 4, wherein the research collaboration engine is further configured to provide an option to search the collection of research data based on at least one keyword or string entered by the user.

6. The research collaboration system of claim 4, wherein the research collaboration engine is further configured to allow a user to create one or more user groups.

7. The research collaboration system of claim 4, wherein the research collaboration system is further configured to provide automatic notification when new research data is added to the research collaboration system.

8. A method for facilitating research collaboration, comprising:
providing by a research collaboration engine at least one predetermined list of genes, pathways, and/or diseases;
receiving by the research collaboration engine a user selection of a search criteria comprising at least one of a gene, pathway, and/or disease from the at least one predetermined list of genes, pathways, and/or diseases; and
based on the user selection, searching by the research collaboration engine a collection of research data for one or more research data entries relating to said search criteria.

9. The method for facilitating research collaboration of claim 8, further comprising automatically notifying a user about the addition of new research data.

10. A computer-readable medium comprising computer program logic encoded thereon for performing the method comprising:
providing at least one predetermined list of genes, pathways, and/or diseases;
receiving a user selection of a search criteria comprising at least one of a gene, pathway, and/or disease from the at least one predetermined list of genes, pathways, and/or diseases; and
based on the user selection, searching a collection of research data for one or more research data entries relating to said search criteria.

11. An apparatus for facilitating research collaboration, comprising:
means for providing at least one predetermined list of genes, pathways, and/or diseases;
means for receiving a user selection of a search criteria comprising at least one of a gene, pathway, and/or disease from the at least one predetermined list of genes, pathways, and/or diseases; and
means for searching, based on the user selection, a collection of research data for one or more research data entries relating to said search criteria.

12. The apparatus for facilitating research collaboration of claim 11, further comprising means for allowing a user to create one or more user groups.

13. The apparatus for facilitating research collaboration of claim 11, further comprising means for automatically notifying a user about the addition of new research data.
